(19) United States
(12) Patent Application Publication
(10) Pub. No.: US 2011/0067542 A1
(43) Pub. Date: Mar. 24, 2011

(54) Multi-Function Power Saw with Tilt Cut

(76) Inventor: Lawrence Oliver Lacy, Clifton Forge, VA (US)

(21) Appl. No.: 12/566,184

(22) Filed: Sep. 24, 2009

(51) Int. Cl. B23D 45/14; B23D 47/02; B23D 45/04

(52) U.S. Cl. 83/471.3; 83/471.2; 83/508.2

(57) ABSTRACT

A power saw includes a saw assembly attached to a base assembly with a tilt mechanism for making non-vertical cuts in such a way that there is a clear path in line with the saw blade, thereby providing a miter saw, a table saw or a radial arm saw. The tilt mechanism employs a saw mount assembly that is affixed to a base assembly and that is engaged to support a saw assembly to make tilted cuts while substantially maintaining the cutting blade in the cutting axis. The saw mount assembly includes a fixed track block and a saw assembly mounting block that is engaged with arc-shaped openings in the track block to rotate about an apparent center point that is inline with the saw blade.

### BACKGROUND OF THE INVENTION

1. Field of the Invention

The present invention relates in general to the field of power saw technology. In one aspect, the present invention relates to a power saw device that combines the functions of a miter saw, a table saw, and a radial arm saw into one portable unit.

2. Description of the Related Art

Conventional woodworking power saws typically perform either a rip cutting function along the length of a board, or a cross cutting function across the length of a board. Whatever the dedicated cutting function, such power saws are usually designed for only one type of cutting function, and are not readily adapted to provide multiple types of cutting functions. For example, table saws that are intended for ripping may be large, fixed units or smaller portable units, and are usually designed to include a base, a slidably-adjustable fence, and a saw assembly with a motor, a switch, a blade, a blade guard, and anti-kickback devices. While cross cuts are possible, they often are difficult and inefficient.

Another example of a conventional power saw is a miter saw which is designed to be portable and to cross cut at various angles. Miter saws are usually designed to include a base, a turntable, fixed fences, and a saw assembly with a motor, a switch, a blade, and a blade guard. The fences may be two separate fences on either side of the blade or one unit that spans the saw blade. The saw assembly is typically attached to the turntable by means of a support that is aligned with the blade. While conventional miter saw supports may be pivoting (which moves the saw assembly up and down), rail mounted (which moves the saw assembly forward and backward) and/or tilting (for cutting angles offset from vertical), the support is typically affixed to the base or turntable in such a way as to prevent or impede rip cuts from being made. Miter saws generally have locking mechanisms to secure the saw assembly in a fixed position for transportation.

Yet another example of a conventional power saw is a radial arm saw which is typically a large, fixed unit that may rip or cross cut. Radial arm saws have a base, a fixed fence, a saw assembly with a motor, one or more rails, a switch, a blade, a blade guard, and anti-kick devices. Generally, the saw assembly moves forward and backward on the rails to make cross cuts. The rail mount may pivot to make angled cross cuts. In addition, the saw assembly may be rotated and locked in a fixed position to make rip cuts or tilted to make non-vertical cuts. Radial arm saws may also make dado cuts part way through the material to form notches by raising and lowering the saw assembly.

As seen from the conventional power saws, a need exists for an improved multi-function power saw apparatus that can be flexibly configured to provide rip cuts, cross cuts and dado cuts. There is also a need for small, portable tools that can be used at various work sites for relatively short periods of time by building contractors and maintenance workers. In addition, there is a need for a more compact and cost efficient multi-function power saw tool for use by home workshop users who need to conserve space and minimize costs. Moreover, there is a need for an improved fence design which may be used with a variety of different power saw designs. Further limitations and disadvantages of conventional systems will become apparent to one of skill in the art after reviewing the remainder of the present application with reference to the drawings and detailed description which follow.

### SUMMARY OF THE INVENTION

Briefly stated, a power saw is provided that may be flexibly configured to perform multiple cutting functions, thereby providing a miter saw, a table saw or a radial arm saw as desired by the user. The power saw includes a saw assembly attached to a base assembly with a tilt mechanism for making non-vertical cuts in such a way that there is a clear path in line with the saw blade, thereby providing a miter saw, a table saw or a radial arm saw. The tilt mechanism employs a saw mount assembly that is affixed to a base assembly and that is engaged to support a saw assembly to make tilted cuts while substantially maintaining the cutting blade in the cutting axis. The saw mount assembly includes a fixed track block and a saw assembly mounting block that is engaged with arc-shaped openings in the track block to rotate about an apparent center point that is inline with the saw blade. A fixed or adjustable offset support enables the flexible configurations by attaching the saw assembly to the turntable in such a way that there is an unobstructed path under the saw in line with the axis of the cutting blade. A movable fence is also provided that may be affixed in a plurality of positions to guide the placement of materials in any of the miter saw, table saw, or radial saw configurations.

In selected embodiments, the power saw includes a saw assembly which includes a cutting blade for cutting along a cutting axis, and which may also include a motor, a blade guard, and an anti-kickback device. In addition, a base assembly (e.g., a table base and turntable with guide channels and a turntable lock) is provided for supporting a board to be cut by the saw assembly, and a saw mount assembly attached to the base assembly and engaged to support the saw assembly over the base assembly to make a tilted cut while substantially maintaining the cutting blade in the cutting axis. The disclosed saw mount assembly may include a track block that is attached to the base assembly and that includes one or more arc-shaped openings defined with reference to an apparent center point that is inline with the cutting axis. For example, the track block may be formed as a single solid body having first and second arc-shaped openings formed therein that are located on concentric arcs defined with reference to the apparent center point. The saw mount assembly also includes a saw assembly mounting block that is attached to the saw assembly and engaged with the one or more arc-shaped openings in the track block to rotate about the apparent center point in relation to the track block. In selected embodiments, the saw assembly mounting block includes one or more rollers which are positioned to engage with the arc-shaped opening(s) in the track block to rotate about the apparent center point in relation to the track block. In other embodiments, the saw assembly mounting block includes one or more protruding flanges which are positioned to engage with the arc-shaped opening(s) in the track block to rotate about the apparent center point in relation to the track block. To lock the track block at a set tilt angle, a locking device may be included as part of the saw mount assembly for affixing the saw assembly mounting block to the track block at a set tilt angle. In addition, a retainer plate may be permanently or releasably affixed to the saw assembly mounting block for securing the saw assembly mounting block to the track block, depending on the assembly method. To enable travel along the cutting axis, a rail support is provided that slidingly engages with the arc-shaped opening(s) in the track block for moving the saw assembly forward and backward in line with the cutting axis. In addition, a slide position lock piece assembly is provided that is permanently or releasably affixed to the saw assembly mounting block and slidingly engaged with the rail support to support movement of the saw assembly forward and backward in line with the cutting axis.

The objects, advantages and other novel features of the present invention will be apparent from the following detailed description when read in conjunction with the appended claims and attached drawings.

### BRIEF DESCRIPTION OF THE DRAWINGS

FIG. 1A depicts an illustrative selected embodiment of the present invention with an exploded view of a tilting type saw mount.

FIG. 1B depicts an illustrative selected embodiment of the present invention with an exploded view of a sliding and tilting type saw mount.

FIG. 2A illustrates a top view of a selected embodiment of an offset support with tilting type saw mount.

FIG. 2B is a back view of the offset support depicted in FIG. 2A.

FIG. 3A is a front view of a selected embodiment of a track block component of an example tilt mechanism.

FIG. 3B is a center cut right view of the track block component depicted in FIG. 3A.

FIG. 4A illustrates a top view of a selected embodiment of a rolling saw mounting block assembly.

FIG. 4B is a front view of the rolling saw mounting block assembly depicted in FIG. 4A.

FIG. 4C is a right side view of the rolling saw mounting block assembly depicted in FIG. 4B.

FIG. 4D illustrates a back view of a selected embodiment of a retaining plate for securing the rolling saw mounting block assembly to the track block component.

FIG. 4E is a side view of the retaining plate depicted in FIG. 4D.

FIG. 5A illustrates a top view of an alternative embodiment of a sliding saw mounting block assembly.

FIG. 5B is a front view of the sliding saw mounting block assembly depicted in FIG. 5A.

FIG. 5C is a right side view of the sliding saw mounting block assembly depicted in FIG. 5B.

FIG. 5D illustrates a back view of a selected embodiment of a retaining plate for securing the sliding saw mounting block assembly to the track block component.

FIG. 5E is a side view of the retaining plate depicted in FIG. 5D.

FIG. 6 is an exploded cross-sectional view of an example sliding and tilting type tilt mechanism assembly.

FIG. 7A illustrates a top view of a selected embodiment of a reversible fence.

FIG. 7B is a side view of the reversible fence depicted in FIG. 7A.

FIG. 7C is a front view of a reversible fence depicted in FIG. 7A.

FIG. 8A is a top view of a selected embodiment of a removable fence.

FIG. 8B is a front view of the removable fence depicted in FIG. 8A.

FIG. 8C is a left view of a removable fence depicted in FIG. 8A.

FIG. 9A is a top view of a selected embodiment of a pivoting fence.

FIG. 9B is a back view of the pivoting fence depicted in FIG. 9A.

FIG. 9C is a left view of a pivoting fence depicted in FIG. 9A.

FIG. 10A is a left view of a blade guard with anti-kickback devices.

FIG. 10B is a front view of a blade guard with anti-kickback devices.

### DETAILED DESCRIPTION

An improved tilting type multi-function power saw device 100 is described whereby the device may be flexibly and readily configured as a miter saw, a table saw and/or a radial arm saw. While various details are set forth in the following description, it will be appreciated that the present invention may be practiced without these specific details. For example, selected aspects are shown in block diagram form, rather than in detail, in order to avoid obscuring the present invention. In addition, the components in the figures are not necessarily to scale, emphasis instead being placed upon illustrating the principles of the invention. Such descriptions and representations are used by those skilled in the power saw arts to describe and convey the substance of their work to others skilled in the art. As described herein, the references in the figures to directions will be from the perspective of an operator or user, such that “front” will be the part of the device closest to the operator, “left” will be the operator's left, “right” will be the operator's right, and “back” will be the part of the device furthest from the operator.

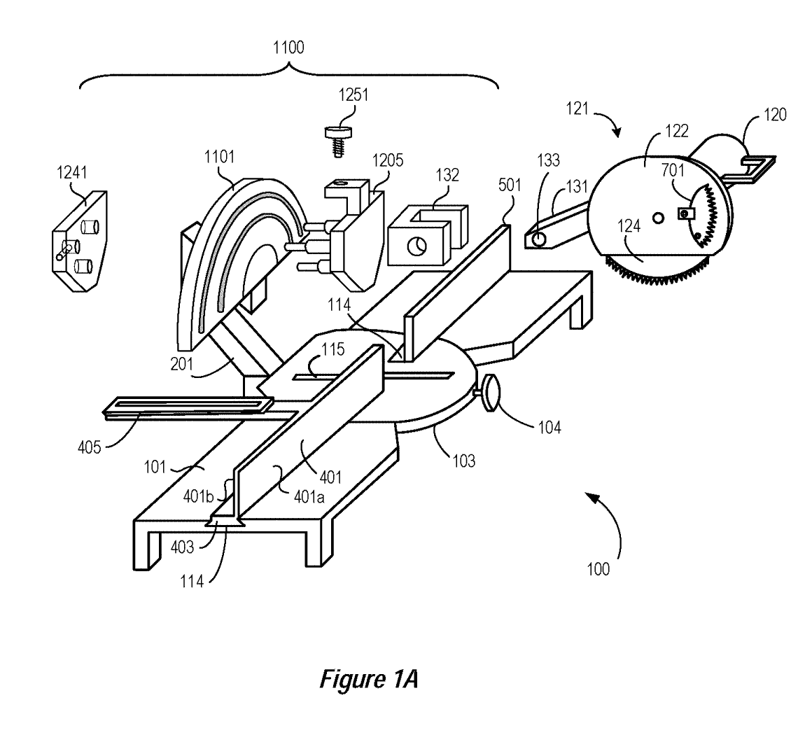

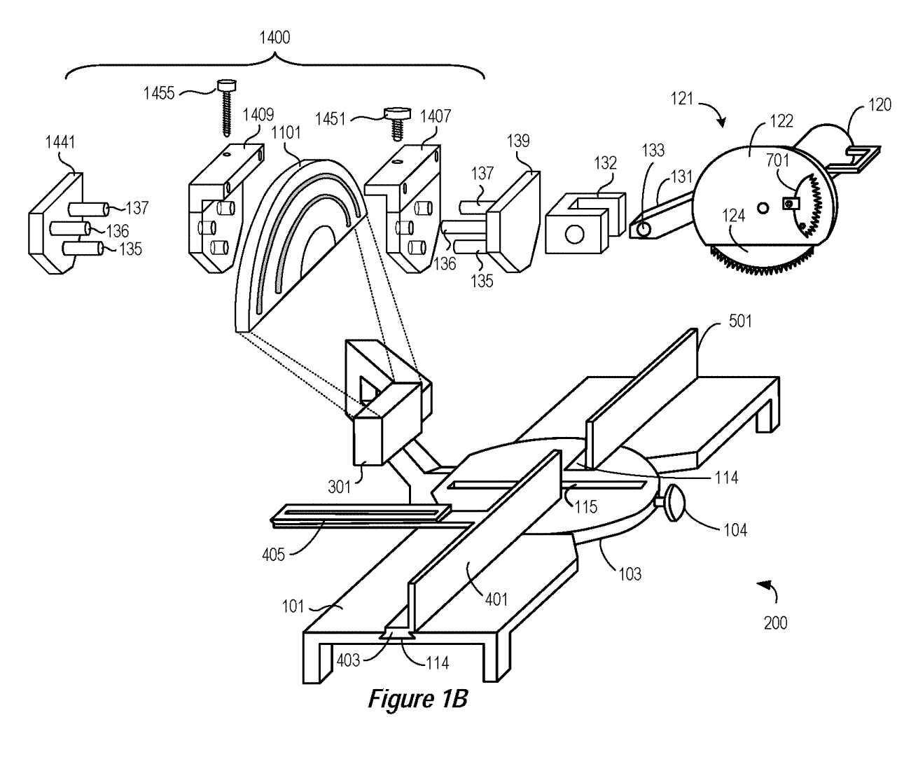

FIG. 1A shows a multi-function power saw device 100 with an exploded view of a tilting type saw mount arrangement, where the power saw device 100 is configured as a miter saw assembly implemented with a tilting type saw mount. The depicted power saw device 100 includes a base 101, an offset support 201, a turntable 103, and a turntable locking mechanism 104. In addition, the power saw device 100 includes a tilting type mounting assembly 1100 shown in exploded view for mounting a saw assembly 121 to the offset support 201 and base 101. With this configuration, the turntable 103 and saw assembly 121 are operably assembled to rotate up to predetermined angles (e.g., 45 or 60 degrees) left and right to enable cuts of various degrees to be made. In addition, the saw assembly 121 is operably mounted to the tilting type mounting assembly 1100 to allow the saw assembly 121 to be tilted with respect to the surface of the turntable 103 for cutting at angles that are offset from vertical.

The depicted saw assembly 121 includes a motor 120, a blade 124, a blade guard 122, a switch (not shown), and a pivoting support 131, 133. The switch is usually a trigger switch which must be held by the user to operate the saw when it is in miter mode. In addition or in the alternative, a run switch (not shown) provides continuous operation of the saw when it is in the rip mode. A safety switch (not shown) ensures that the saw blade is locked in the rip or dado position prior to operation.

In accordance with selected embodiments of the present invention, the saw assembly 121 is supported by a pivoting support 131, tilting type mounting assembly 1100, and offset support 201. The depicted offset support 201 supports the tilting type mounting assembly 1100 and saw assembly 121 with a laterally displaced support assembly that provides a clear path in line with the axis of the saw blade 124 so that boards moving along the front/back axis of the device can be rip cut when the power saw device is configured as a table saw. Whatever the cutting configuration of the power saw device, the pivoting support 131 allows the saw assembly 121 to be raised and lowered by rotation around its pivoting axis, and may be locked in a fixed position by a pivot locking mechanism 133.

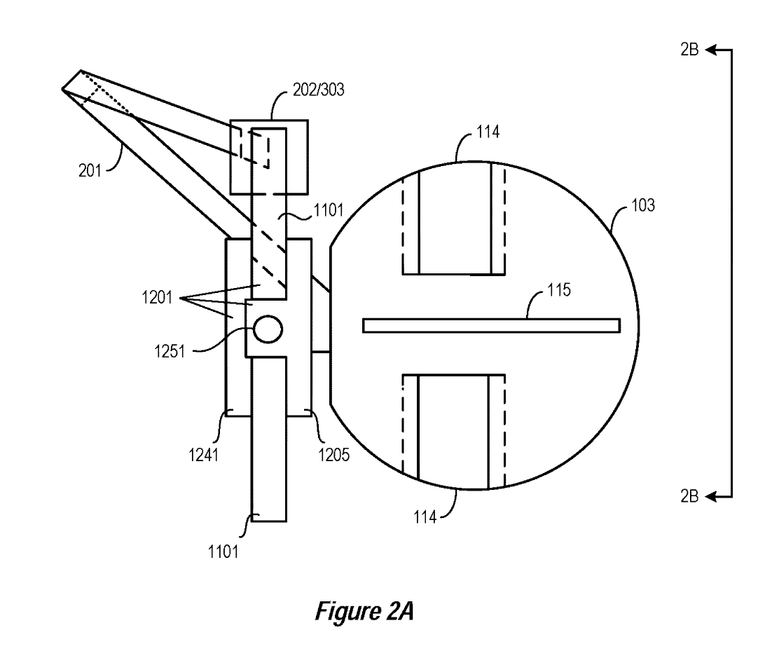

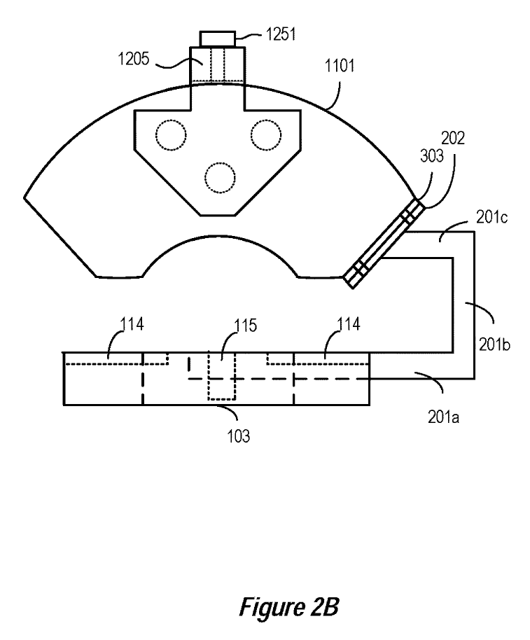

To enable the saw assembly 121 to be tilted for cutting at angles that are offset from vertical, the tilting type mounting assembly 1100 is provided to allow the saw assembly 121 to be tilted with respect to the surface of the turntable 103. As illustrated in FIGS. 1A and 2A-D, the tilting type mounting assembly 1100 includes a retainer plate 1241, a track block 1101 affixed to the offset support 201, a saw mounting block assembly 1205, 1251, and a connection piece 132. While the connection piece 132 is shown as a separate component, it may be integrated into the design of saw mounting block assembly 1205. The saw mounting block assembly 1205 is mated with the positionally-fixed track block 1101 in a manner that provides angular motion between the two components with an apparent center point that is inline with the cutting axis of the saw blade 124 in the cutting channel 115 and that is slightly below the upper surface of the turntable 103. In particular, the bottom of the saw blade 124 is aligned with the apparent center point such that the cutting axis of the saw blade 124 lies along the radius of the tilting arc created by the movement of the saw mounting block assembly 1205 in relation to the track block 1101. With the track block 1101 being fixed in a stationary position so that the saw mounting block assembly 1205 moves in relation to it, tilted cuts can be made on either left or right of vertical at various desired angles. To secure a desired tilted angle cut, the locking device 1251 affixes the saw mounting block assembly 1205 to the track block 1101 at the desired tilt angle. Thus, the track block 1101 may be mounted at the top of the offset support 201, such as by means of mounting brackets 202, 303. With this mounting, the track block 1101 is displaced from the cutting surface of the turntable 103 while providing an apparent tilt axis near the top surface of the turntable 103 which assures that saw blade 124 is aligned with cutting channel 115 in turntable 103.

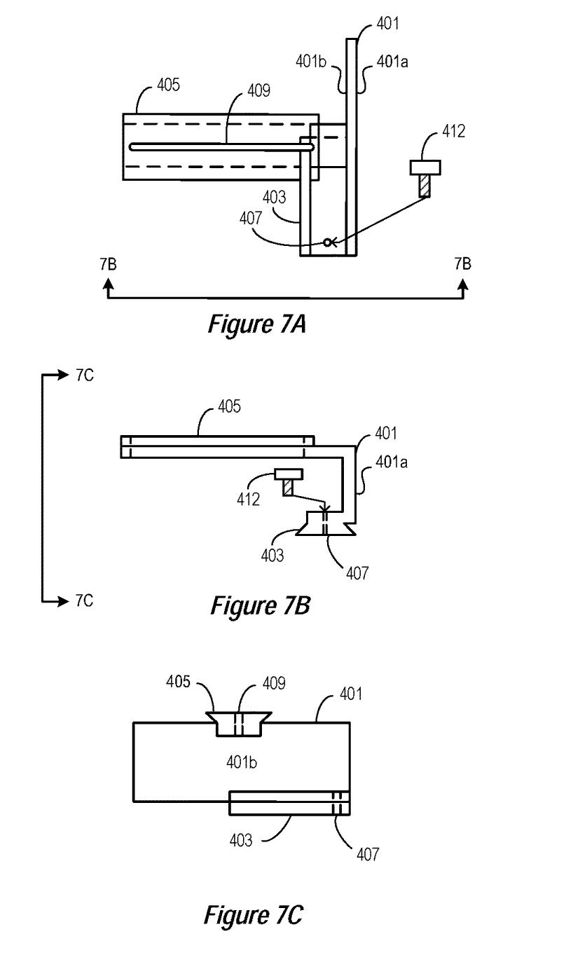

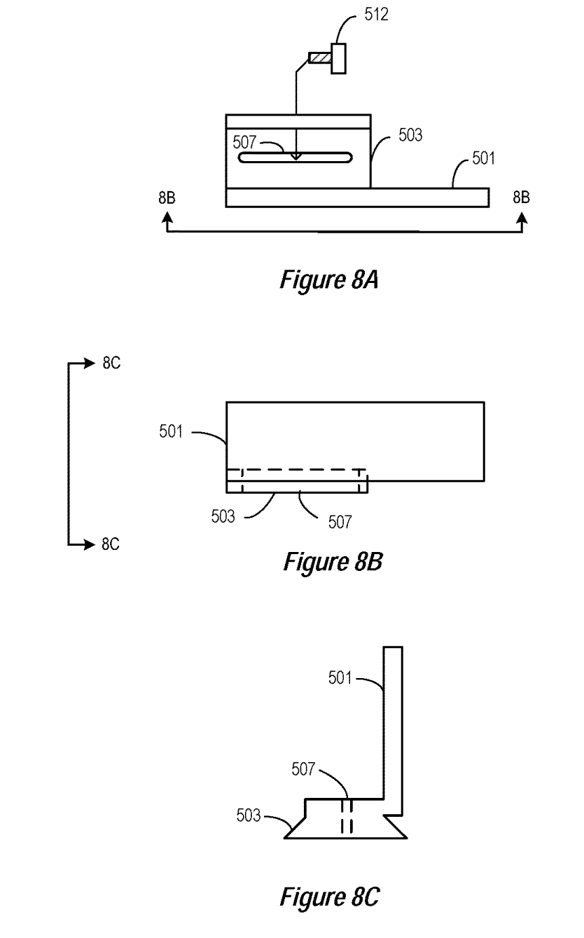

In accordance with another illustrative embodiment of the present invention illustrated in FIGS. 1A and 1B, the multi-function power saw device 100 includes a reversible fence 401 (illustrated more fully in FIGS. 7A, 7B, and 7C). As illustrated in the miter saw configuration of FIG. 1A, the reversible fence 401 includes a miter position slide member 403 that is slidably engaged in the guide channel 114 of the base 101. While a dovetail guide channel 114 is illustrated in the figures, it will be appreciated by persons having ordinary skill in the mechanical arts that other configurations and fixture techniques will serve the same function. In addition, the multi-function power saw device 100 may include a removable fence 501 that is provided for use in the miter saw configuration, but that may be removed when the multi-function power saw device 100 is configured as a table saw. As illustrated more fully in FIGS. 8A, 8B, and 8C, the removable fence 501 includes a miter position slide member 503 that is slidably engaged in the guide channel 114 of the base 101. In the configuration depicted in FIG. 1A, the front or guiding faces of the reversible fence 401 and removable fence 501 are used to guide or secure a board that is being cross cut by the blade 124.

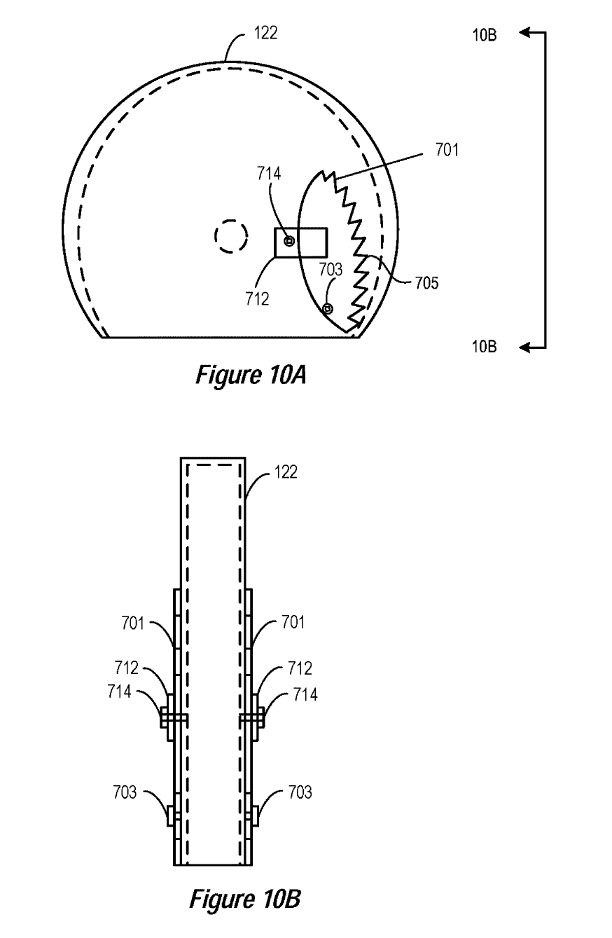

The multi-function power saw device 100 depicted in FIG. 1A may be converted into table or radial arm saw configuration by locking the saw assembly 121 in the correct position with pivot lock 133 which activates a safety switch (not shown). Upon unlocking the removable fence 501 (see FIG. 8A), the fence 501 may be moved or removed. In addition, reversible fence 401 may be unlocked (see FIG. 7B) and reversed such that the table saw position slide member 405 is inserted into guide channels 114 in base 101 only or in both the base 101 and turntable 103. In this table saw configuration, the guiding face of reversible fence 401 is aligned in parallel to the axis of blade 124 and may be locked into a position at the desired distance from blade 124. For example, the turntable 103 or base 101 may include a visual indication (such as a scale or ruler (not shown) affixed to base 101) to indicate the rip width of the cut. Once anti-kickback devices 701 (illustrated more fully in FIGS. 10A and 10B) are lowered into the rip position, a run switch (not shown) is activated by the user. Conversely, a multi-function power saw device 100 configured as a table saw may be converted to a miter saw configuration by reversing the position of the fence 401 and inserting the removable fence 501 into the guide channels 114.

As will be appreciated, the saw assembly 121 may be affixed to the base 101 in a variety of different ways without impairing the ability of the power saw device to be configured in multiple cutting configurations. For example, the pivot support 131, connection piece 132, and saw assembly 121 of the multi-function power saw device 200 depicted in FIG. 1B may be connected via a tilting type mounting assembly 1400 to a rail support 135-139 for slidable engagement with track block 1101. FIG. 1A shows that track block 1101 may be affixed to the end of the offset support 201, while FIG. 1B shows the alternative use of a mounting block 301 which may have a variety of different physical configurations. It will appreciated that the track block 1101 may be mounted from its front, back, top, bottom, or side, provided that the mounting arrangement does not interfere with the movement of tilt assembly 1100, 1400 or the movement of a board beneath the mounting mechanism. In the arrangement illustrated in FIG. 1B, the saw assembly 121 moves forward and backward along the rail support shafts 135, 136, 137, and may be locked in place by the slide position lock piece assembly 1409, 1455 of the tilting type mounting assembly 1400. As described more fully hereinbelow, the tilting type mounting assembly 1400 includes a retainer plate 1441, a slide position lock piece assembly 1409, 1455, a track block 1101 affixed to the offset support 301, and a saw mounting block assembly 1407, 1451. The retainer plate 1441 may be permanently or releasably affixed to the rail support shafts 135, 136, 137 for securing the tilting type mounting assembly 1400, depending on the assembly and/or maintenance considerations. For example, the retainer plate 1441 may be permanently attached prior to assembly depending upon the assembly method. If plate 303 (shown in FIG. 2B) is separate from the rest of block 1101, then the tilt assembly may be inserted into the tracks from the end, and the end would then be closed by plate 303. When assembled and connected, the tilting type mounting assembly 1400 allows the saw assembly 121 to slidably engage with the rail support 135-139 and also to tilt with respect to the surface of the turntable 103 for cutting at angles that are offset from vertical.

Turning now to FIGS. 2A and 2B, top and back views, respectively, are illustrated of a selected embodiment of an offset support with tilting type saw mount that is attached to a turntable 103. In particular, FIG. 2A illustrates a top view of the turntable 103, offset support 201, and assembled tilting type mounting assembly 1201, while FIG. 2B illustrates a front view (from the perspective of the “2B-2B” line in FIG. 2A) of the offset support depicted in FIG. 2A. As depicted, the turntable 103 includes guide channels 114 and a cutting channel 115. The offset support 201 is affixed to the back of the turntable 103, and as shown in FIG. 2B, includes a lower lateral extension member 201a, a vertical extension member 201b and an upper lateral extension member 201c. Though shown in a fixed height configuration, it will be appreciated that the offset support 201 may be implemented as a height-adjustable offset support so that the height of the saw assembly 121 may be adjusted to make dado cuts. Of course, a variety of different height adjustment schemes may be used, including, but not limited to, securing the saw assembly at various positions between the highest pivot point and the lowest pivot point, inclusive. In addition, scale markings (not shown) may be provided on the height-adjustable offset support to indicate blade height. It will also be appreciated that the lengths, angles and shapes of the extension members in offset support 201 may be varied to achieve any desired position(s), both horizontally and vertically, of the assembled tilting type mounting assembly 1201 and saw assembly 121 with respect to turntable 103. In addition, the offset support 201 may be positioned to the left or right of turntable 103, so long as an unobstructed path is provided for a board moving along the front/back axis of the turntable 103.

As shown in FIG. 2B, a mounting bracket 202 is attached to the offset support 201 that is compatible with the mounting bracket 303 on the track block 1101. With the track block component 1101 of the assembled tilting type mounting assembly 1201 affixed to the offset support 201, the saw mounting block assembly 1205, 1251 may be slidably engaged with the track block 1101 to provide angular motion for the saw assembly (not shown in FIG. 2B) in relation to the track block 1101, thereby allowing cuts to be made either left or right of vertical at various desired angles.

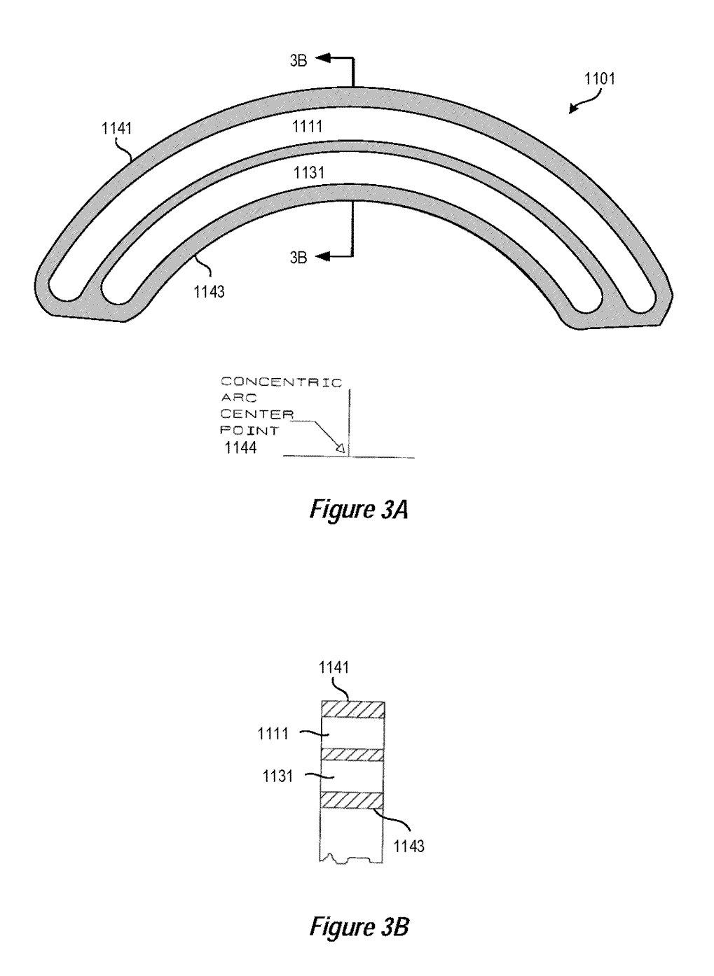

Turning now to FIGS. 3A and 3B, there are illustrated detailed views of a selected embodiment of the track block component 1101 of an example tilt mechanism. In particular, FIG. 3A illustrates a front view of the track block component 1101, while FIG. 3B illustrates a center cut right or side view of the track block component 1101 (from the perspective of the “3B-3B” line in FIG. 3A). As illustrated, the track block component 1101 includes an upper or outer groove track opening 1111 and a lower or inner groove or track opening 1131 that are located on concentric arcs between an upper surface 1141 and a lower surface 1143. As shown in the cross-sectional view of FIG. 3B, the groove track openings 1111, 1131 may extend completely through the body of the track block component 1101. The track block component 1101 may be laminated or formed or manufactured as a single solid formed piece in which one or more concentric track openings 1111, 1131 are formed to permit mating engagement by one or more sliding or rolling member components from a saw mounting block assembly, as described more fully hereinbelow. Movement along the concentric track openings 1111, 1131 provides angular movement about a common apparent center point 1144. If movement along the tracks openings 1111, 1131 is accomplished with rolling member components, then two concentric paths are used to provide stable movement about the apparent center point 1144, but if movement along the tracks openings 1111, 1131 is accomplished with sliding member components, then a single track opening path will provide stable movement about the apparent center point 1144. In addition or in the alternative, the upper surface 1141 and/or lower surface 1143 may also be formed as concentric surfaces that are used as external tracks to provide angular movement about the apparent center point 1144.

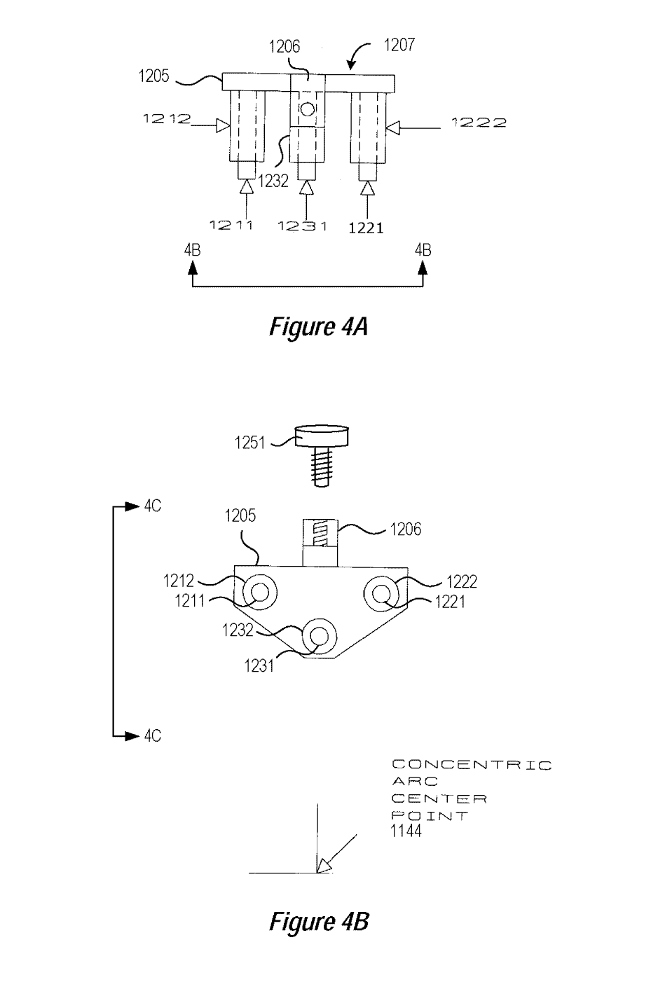

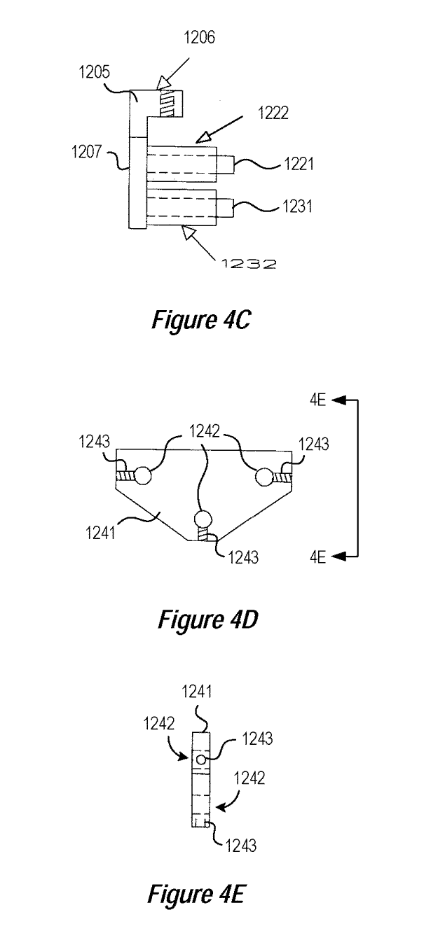

To mate with the track block 1101, a rolling saw mounting block assembly 1201 may be provided, such as illustrated with references to FIGS. 4A-E. In the depicted example, the rolling saw mounting block assembly 1201 includes a saw mounting block or body 1205, a locking mechanism 1206, 1251, one or more rollers 1212, 1222, 1232 and associated shafts 1211, 1221, 1231, and a retainer plate 1241. As stated above it should be apparent that at least two shafts and roller combinations are required to provide stable movement about the apparent center point.

Shown from the top view in FIG. 4A, the rolling saw mounting block assembly 1201 includes a saw mounting body 1205 that provides a back surface 1207 or other attachment mechanism for attachment to the saw assembly. However, it will be appreciated that the actual design of the attachment mechanism will depend upon the design of the saw assembly to be attached. As shown in FIGS. 4A and 4B, the saw mounting body 1205 incorporates one or more circular shafts 1211, 1221, 1231 which protrude from the front face of the saw mounting body 1205. By correctly positioning the shafts 1211, 1221, 1231, the shafts have the same apparent center point 1144 as track block 1101 (shown in FIG. 3A). On the shafts, a corresponding number of circular rollers 1212, 1222, 1232 are assembled to rotate about the shafts 1211, 1221, 1231. As shown in the side view of FIG. 4C, the shafts 1211, 1221, 1231 extend through the rollers 1212, 1222, 1232 to permit locking engagement with the retainer plate 1241 (depicted in FIGS. 4D and 4E). In this way, the upper rollers 1212 and 1222 from the saw mounting body 1205 may be positioned to mate and roll within the upper track opening 1111 of the track block 1101, and the lower roller 1232 from the saw mounting body 1205 may be positioned to mate and roll within lower track opening 1131 of the track block 1101. While a shaft and roller assembly is shown, it will be appreciated that other types of rollers can be used, including, but not limited to, using bushings and bearings to achieve angular movement between the track block 1101 and the rolling saw mounting block assembly 1201. In addition, one or more rollers may be used in conjunction with each inner track or external track of track block 1101.

To secure the rolling saw mounting block assembly 1201 to the track block 1101, a retainer plate 1241 may be employed. An example implementation of the retainer plate 1241 is illustrated with the back and side views of the retainer plate 1241 depicted in FIGS. 4D and 4E. As shown, the retainer plate 1241 may be formed or manufactured as a single solid formed piece having any desired shape, though a plurality of pieces may be assembled together to form a single retainer plate. In the retainer plate 1241, one or more openings 1242 are formed in a position to receive the one or more shafts 1211, 1221, 1231 from the rolling saw mounting block assembly 1201. In addition, screw holes 1243 may be formed to intersect with the one or more openings 1242 so that the retainer plate 1241 may be secured to the shafts 1211, 1221, 1231 with set screws. However, it will be appreciated that other techniques may be used to secure the retaining plate 1241 to the rolling saw mounting block assembly 1201, including but not limited to using individual retainers for each shaft, tension rings, clips, tension pins, and the like. In addition, it will be appreciated that the retaining plate 1241 may be removable or un-removable.

On the rolling saw mounting block assembly 1201, a locking mechanism 1251 is used to maintain the desired tilt position of the saw assembly in relation to the track block 1101. As depicted, the locking mechanism 1251 may be implemented as a knob and screw so that the screw extends through a screw hole in the saw mounting block assembly 1205 to contact the track block 1101. However, other position locking techniques may be used to achieve the same result, including, but not limited to, cams, clamps, and/or pins. In addition, it will be appreciated that such position locking devices may be installed in any convenient position in relation to saw mounting block 1201 (i.e., top, bottom, front, back, and/or side).

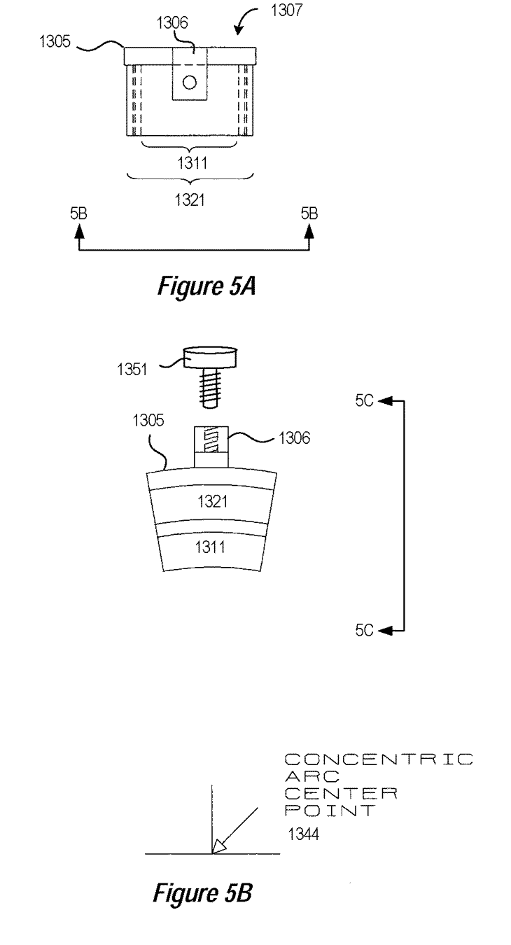

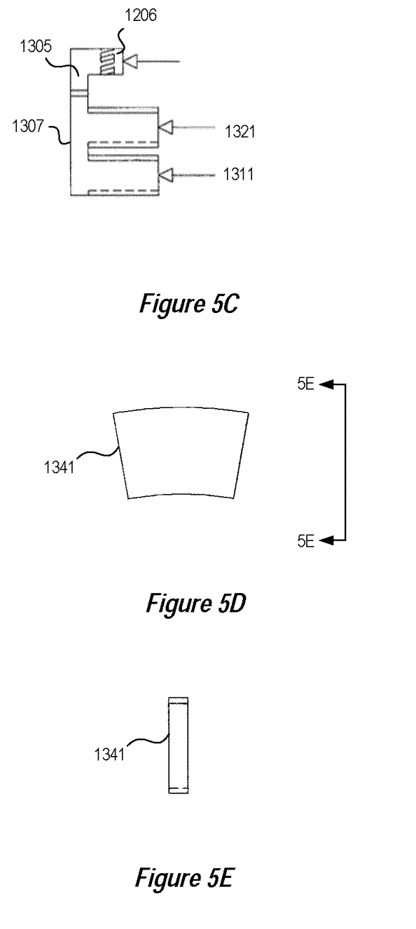

While FIGS. 4A-E illustrated a rolling-type saw mounting block assembly 1201 which provides angular movement with respect to the track block component 1101, other mechanisms may also be used to achieve angular movement between the track block 1101 and the saw assembly. For example, a sliding saw mounting block assembly may be provided to mate with the track block 1101, such as illustrated with reference to FIGS. 5A-E. In the depicted example, the sliding saw mounting block assembly includes a saw mounting block or body 1305 having a back surface 1307 or other attachment mechanism for attachment to the saw assembly, a locking mechanism 1306, 1351, one or more protruding flange members 1311, 1321, and a retainer plate 1341. In this example, a single protruding flange member(s) may be shaped and formed to mate with one of the groove track openings in the track block 1101 and still provide stable movement about the apparent center point 1344. As illustrated in FIGS. 5A-C, the protruding flange members 1311, 1321 are shaped to engage and move within or about the guide tracks or surfaces of track block 1101 so that the upper arced flange member 1321 fits within the upper track 1111 of track block 1101 while the lower arced flange member 1321 fits within the lower track 1131 of track block 1101. Thus, multiple flanges and tracks may be used, but in selected embodiments, only one track and one flange are necessary to provide stable movement about the apparent center point 1344. In addition or in the alternative, the tracks and flanges may be engaged with upper or lower external surfaces of the track block 1101.

To secure the sliding saw mounting block assembly to the track block 1101, a retainer plate 1341 may be employed which serves the same purpose as the retainer plate 1241 described hereinabove. As illustrated with the example implementation of the retainer plate 1341 depicted in FIGS. 5D and 5E, the retainer plate 1341 may be formed or manufactured as a one or more solid formed pieces having any desired shape. In addition, any desired attachment mechanism may be used to secure the retainer plate 1341 to the saw mounting block or body 1305, such as forming one or more screw openings in the retainer plate 1341 (not shown) in a position to intersect with the one or more protruding flange members 1311, 1321 so that the retainer plate 1341 may be secured with set screws (not shown). However, it will be appreciated that other techniques may be used to secure the retaining plate 1341 to the saw mounting block assembly 1305, including but not limited to using individual retainers for each flange, tension rings, clips, tension pins, and other methods common in the trades.

The sliding saw mounting block assembly also includes a locking mechanism 1351 that may be used to maintain the desired tilt position of the saw assembly in relation to the track block 1101. Similar to the locking mechanism 1251 described in FIG. 4A, the locking mechanism 1351 may be implemented as a knob and screw so that the screw extends through a screw hole in the saw mounting block assembly 1305 to contact the track block 1101, though other position locking techniques may be used to achieve the same result, including, but not limited to, cams, clamps, and/or pins. It will be appreciated that such position locking devices may be installed in any convenient position in relation to the sliding saw mounting assembly (i.e., top, bottom, front, back, and/or side).

FIGS. 4A-E and 5A-E illustrate selected exemplary configurations tilting the saw assembly in relation to the underlying table saw using a rolling or sliding saw mounting block assembly. However, the design of saw mounting block assembly may be varied to accommodate various saw designs. For example, instead of affixing the track block component 1101 to the offset support 201 so that the sliding saw mounting block assembly (and attached saw assembly) rotate in relation to the track block component 1101, the two components may be mounted in the opposite manner with the saw mounting block assembly attached to the offset arm 102 and the track block component 1101 attached to the saw assembly. In this case, the saw mounting block assembly is stationary and the track block moves in relation to the mounting block.

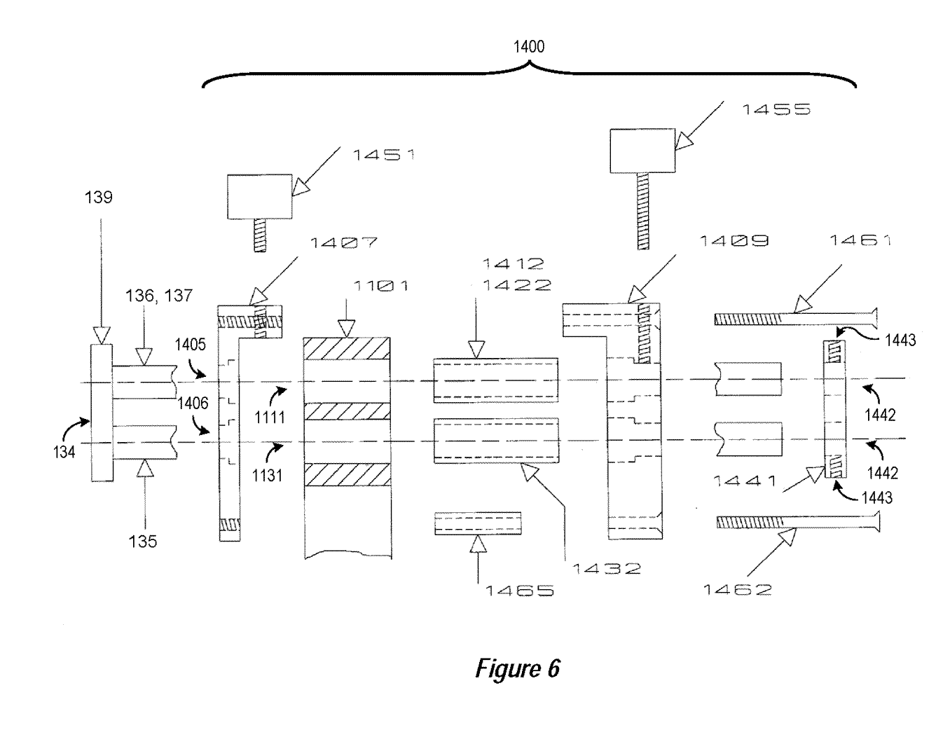

As will be appreciated, other configurations may be used to provide a tilted angle cut for the saw assembly, such as the tilt/slide saw mounting assembly 1400 shown in FIG. 1B as being mounted on the rail support assembly 135-139 for slidable engagement in relation to the offset support 301. To better understand how the components of the tilt/slide saw mounting assembly 1400 are assembled, reference is now made to FIG. 6 which depicts an exploded side and cross-sectional view of the tilt/slide saw mounting assembly 1400. As depicted, the assembly 1400 is attached to the saw assembly to provide linear movement of the along the axis of the saw blade while also providing tilting movement. In particular, the view of FIG. 6 is from the right side of the multi-function power saw device 200 as viewed from the operator's position while the device is in the miter saw configuration. In other words, the left side of the drawing in FIG. 6 is the front of the device to which the saw assembly 121 is attached.

As shown at the left side of FIG. 6, the rail support assembly includes one or more sliding shafts 135-137 which are affixed to a first end plate 139 on one end of the shafts 135-137. The first end plate 139 provides a mounting surface 134 for attaching the saw assembly, and also acts as a base for shafts 135-137. On the opposite end, the shafts 135-137 are attached to a retainer plate 1441, thereby providing a stable sliding type rail support structure. In the configuration shown in FIG. 6, the rail support assembly 135-137, 139 is not part of the tilt assembly, but instead moves linearly in relation to the tilt/slide saw mounting assembly 1400. To this end, each of the shafts 135-137 extends through a groove track opening 1111, 1131 in the track block component 1101, where each groove track opening is formed as a concentric arc which provides angular movement about a common apparent center point at the cutting table surface. In the depicted example, the track block component 1101 is affixed in relation to the underlying saw table, such as by physical attachment to an offset support 301 shown in FIG. 1B.

To engage with the track block component 1101 and rail support assembly 135-137, 139, the tilt/slide saw mounting assembly 1400 includes a retainer plate 1441, a slide position lock piece assembly 1409, 1455, rollers 1412, 1422, 1432, and a saw mounting block assembly 1407, 1451. As shown, the shafts 135-137 of the rail support assembly have a predetermined length which enables the tilt/slide saw mounting assembly 1400 to slide forward and backward inside rollers 1432, 1412, 1422 that are mounted on the shafts 135-137. Thus, the shaft length depends upon the desired linear movement, and the rollers 1432, 1412, 1422 serve as sleeves for the shafts 135-137.

As indicated above, FIG. 6 shows that the rail support assembly 135-137, 139 is not part of the tilt assembly, but moves linearly in relation to the tilt/slide saw mounting assembly 1400. This results from the fact that the rollers 1412, 1422, 1432 are recessed into the tilt position body 1407 and the slide position body 1409, thereby holding the rollers in place while the assembly 1400 rotates in the track block 1101. However, it will be appreciated that the rollers need not be recessed, and may also be sandwiched between the tilt position body 1407 and the slide position body 1409, in which case the assembly 1400 would not rotate in the track block 1101 because the shafts would be necessary to hold the rollers in place making everything part of one unit.

The slide position body 1409 and the tilt position body 1407 may be attached together with fastener screws 1461 and 1462 that are inserted between aligned openings in the bodies 1409, 1407, though other attachments techniques may be used, including but not limited to bolts, rivets, tension pins and/or welding techniques. As formed, the slide position body 1409 and tilt position body 1407 have openings 1405, 1406 formed to receive and seat the rollers 1412, 1422, 1432 between the bodies 1409, 1407, while also allowing the shafts 135-137 to extend through the bodies 1409, 1407. In addition, a spacer shaft 1465 may be used receive one of the fastener screws (e.g., 1462) in order to maintain a uniform distance between the bodies 1407 and 1409, though it will be appreciated that one or more protruding flange members from the slide position body 1409 and/or the tilt position body 1407 may be used in lieu of the spacer shaft 1465. With the depicted assembly, the fastener screws 1461, 1462 effectively lock the slide position body 1409 and the tilt position body 1407 with the rollers 1412, 1422, 1432 together to engage with the track block component 1101, thereby forming a tilt/slide saw mounting assembly 1400 which has both a tilting motion (by virtue of the movement of the rollers 1412, 1422, 1432) and a sliding motion (by virtue of sliding along the shafts 135-137). While the slide position body 1409 and the tilt position body 1407 are shown as separate pieces because of assembly considerations, it will be understood that these bodies 1407, 1409 form one functional component, and may optionally be formed as a single piece using other manufacturing techniques known in the industry.

The tilt/slide saw mounting assembly 1400 also includes a retainer plate 1441 for securing one or more of the shafts 135-137. This is done by locating the retainer plate 1441 up against the slide position body 1409 after the slide position body 1409 and the tilt position body 1407 are connected together with fastener screws 1461, 1462. Though the retainer plate 1441 may be formed or manufactured as a single solid formed piece having any desired shape, a plurality of pieces may be assembled together to form a single retainer plate 1441. In the retainer plate 1441, one or more openings 1442 are formed in a position to receive the one or more shafts 135-137. In addition, screw holes 1443 may be formed to intersect with the one or more openings 1442 so that the retainer plate 1441 may be secured to the shafts 135-137 with set screws. Although the retainer plate 1441 is shown as being secured with set screws, it will be appreciated that other methods may be employed to effect the same purpose. These methods may include but are not limited to individual retainers for each shaft, tension rings, clips, and/or tension pins. As will be appreciated, the shafts, rollers, mounting plate, and retainer plate for the tilt/slide saw mounting assembly 1400 correspond closely to the shafts, rollers, mounting plate, and retainer plate described in FIGS. 4A-4E, except that the shafts are longer.

To secure the tilt position body 1407 in the desired tilt position in relation to the tilt block component 1101, a locking mechanism 1451 is included or attached to the tilt position body 1407. In selected embodiments, the locking mechanism 1451 is implemented with one or more knob and screw mechanisms 1451 which extend through corresponding screw hole(s) in the tilt position body 1407 to contact the track block component 1101. Of course, other locking mechanisms may be employed, including but not limited to cams, clamps, and/or pins.

In similar fashion, the slide position body 1409 may be secured in the desired front-to-back position in relation to the rail support assembly 135-137, 139 with a slide locking mechanism 1455 that is included or attached to the slide position body 1409. While the slide locking mechanism 1451 may be implemented with one or more knob and screw mechanisms 1455 which extend through corresponding screw hole(s) in the slide position body 1409 to contact at least one of the shafts 135-137, it will be appreciated that other slide locking mechanisms may be employed, including but not limited to cams, clamps, and/or pins.

Cutting operations may be facilitated in connection with the multi-function power saw device of the present invention by providing predetermined markings and/or settings on the device to assist with the sizing and placement of board cuts. For example, scale markings may be affixed to the fixed tilt block component 1101 to indicate the degree of tilt. In addition, preset stops for commonly used tilt angles may be affixed to the fixed tilt block component 1101. Likewise, a ruler on the turntable 103 or base 101 may indicate distances along the rip cut and cross cut directions.

FIGS. 7A-C illustrate a top view, side view and front view of a selected embodiment of a reversible fence. In particular, FIG. 7A illustrates a top view of the reversible fence 401, while FIG. 7B illustrates a side view of fence 401 (from the perspective of the “7B-7B” line in FIG. 7A) and FIG. 7C illustrates a back view of fence 401 (from the perspective of the “7C-7C” line in FIG. 7B). As depicted in FIGS. 7A-C, the reversible fence 401 includes a miter position slide member 403 that is configured for insertion into a guide channel 114 in the base 101. Once engaged in the base 101 in a miter saw configuration, a locking device 412 may be used to lock the fence 401 into position by inserting the locking device 412 through a hole 407 formed in the fence 401 and into a hole in the base 101 (not shown) corresponding with hole 407. It will be appreciated that other methods of securing the fence in the desired position may be used.

The reversible fence 401 also includes a table saw position slide member 405 extending perpendicularly from the front or guiding face of the reversible fence 401. The table saw position slide member 405 is configured for insertion into a guide channel 114 in the base 101 and turntable 103 when the power saw is configured as a table saw to make rip cuts. Thus, in the rip position, the table saw position slide member 405 is inserted into guide channel 114 and may be locked or secured into a predetermined position with locking device 412 which fits through a slot 409 formed in the member 405 and into a hole in the base 101 (not shown). Slot 409 allows the reversible fence 401 to be moved toward or away from blade 124 to obtain different widths of rip cuts. It will be appreciated that other methods of securing the fence in the desired position may be used.

FIGS. 8A-C illustrate a top view, front view and side view of a selected embodiment of a removable fence. In particular, FIG. 8A illustrates a top view of the removable fence 501, while FIG. 8B illustrates a front view of fence 501 (from the perspective of the “8B-8B” line in FIG. 8A) and FIG. 8C illustrates a left or side view of fence 501 (from the perspective of the “8C-8C” line in FIG. 8B). As depicted in FIGS. 8A-C, the removable fence 501 includes a miter position slide member 503 that is configured for slidable engagement with guide channel 114 in the base 101. Once engaged in the guide channel, a locking device 512 may be used to lock the removable fence 501 into position by inserting the locking device 512 through slot 507 formed in the fence 501 and into a hole in the base 101 (not shown). When the power saw is configured as a table saw to make rip cuts, slot 507 allows the removable fence 501 to be moved to provide clearance for the material being cut. In addition, fence 501 may be removed altogether. It will be appreciated that other methods of securing the fence in the desired position may be used.

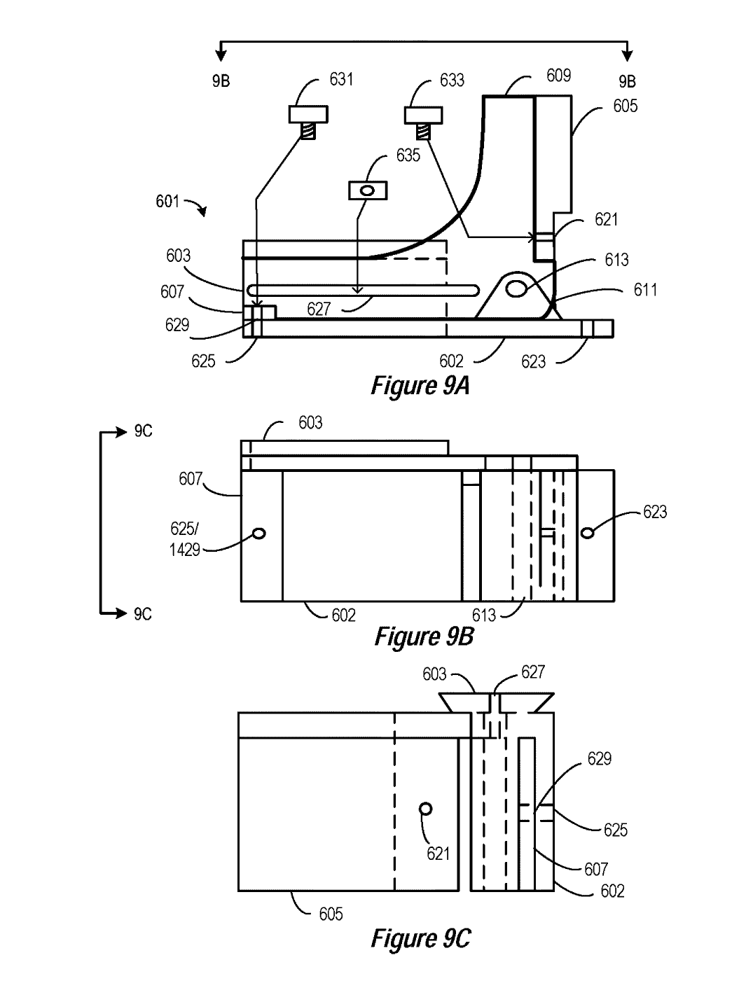

Turning now to FIGS. 9A-C, top, back and left views, respectively, are illustrated of a selected embodiment of a pivoting fence 601 that may be attached to base 101. In particular, FIG. 9A illustrates a top view of the first pivoting fence member 602 and second pivoting fence member 605, while FIG. 9B illustrates a back view of a pivoting fence members 602, 605 (from the perspective of the “9B-9B” line in FIG. 9A) and FIG. 9C illustrates a left or side view of a pivoting fence members 602, 605 (from the perspective of the “9C-9C” line in FIG. 9B). As depicted in FIGS. 9A-C, the pivoting fence member 605 is affixed to a slide member 603 that is configured for insertion into a guide channel 114 in the base 101 and turntable 103. The slide member 603 may then be locked into engagement with the base 101 with locking device 635 which fits through slot 627 and into a hole in base 101 (not shown). It will be appreciated that other methods of securing the fence in the desired position may be used.

When the multi-function power saw device is configured as a miter saw, the pivoting fence member 602 may be held in the miter position (as illustrated in FIG. 9A) with a locking device 631 which fits through a hole 629 in post 607 and into hole 625 in the pivoting fence 601. In this configuration, the front or guiding face of the pivoting fence 601 (bottom of FIG. 9A) is used to guide or secure a board that is being cross cut by the blade 124.

On the other hand, when the multi-function power saw device is configured as a table saw to perform rip cuts, the pivoting fence member 602 may be rotated counter-clockwise about pivot point 613 so that the front or guiding face of the pivoting fence member 602 (bottom of FIG. 9A) is aligned with the guiding face of the pivoting fence member 605 (on the right side of FIG. 9A). To configure the pivoting fence for rip cuts, the locking device 631 is released and fence member 602 is pivoted about pivot point 613 via hinge 611. To secure the pivoting fence member for rip cuts, a locking device 633 is provided that fits through hole 621 in fence 605 and into hole 623 to form a continuous rip fence. In this configuration, the front or guiding faces of the pivoting fence members 602 and 605 are aligned to guide or secure a board that is being rip cut by the blade 124. The slot 627 allows the pivoting fence 601 to be moved toward or away from blade 124 to obtain different widths of rip cuts. As will be appreciated, various fence shapes and configurations may also be used, such as having a multi-piece pivoting fence (e.g., a base, a lower fence and an upper fence) or having a removable fence with a lower fence and an upper fence, where the upper fence slides in relation to the lower fence.

FIGS. 10A-B illustrate a left or side view and front view of a selected embodiment of a blade guard with an anti-kickback device. In particular, FIG. 10A illustrates a side view of the anti-kickback device, while FIG. 10B illustrates a front view of anti-kickback device (from the perspective of the “10B-10B” line in FIG. 10A). As depicted in FIGS. 10A and 10B, the saw assembly includes a blade guard 122 with an anti-kickback device 701 which rotates about pivot point 703 (which may be a screw, bolt or the like) and which is held in the stored position for miter operations by retainer 712 attached to blade guard 122 by fastener 714. For ripping and dado operations, the anti-kickback device 701 is rotated to a down position about the axis of fastener 703. The teeth 705 of the anti-kickback device 701 may be slanted counter-clockwise at a predetermined angle so that the teeth 705 slant to the right (from the perspective depicted in FIG. 10A) when the device 701 is rotated down. The slanted teeth 705 allow material or cutting boards to move freely from left to right, but will stop or snag any material moving right to left (such as occurs when there is kickback). It will be appreciated that other methods of providing anti-kickback protection may be employed. For example, a device similar to device 701 may be mounted in various positions inline and behind the saw blade, such as on the saw mounting block, the support arm, the track block, or elsewhere.

As described herein, the offset support, saw assembly support, tilt mechanism, and/or fences can be made to be either “right handed” or “left handed” so as to function on either side of the saw blade. To facilitate measurements of the cutting angles, heights, depths and the like, various preset stops and markings may be provided specifying the cutting blade height and angle, such as a rip scale on the device base and turntable, a tilt scale on the tilt mechanism, preset stops on the tilt mechanism, preset stops on the height adjustment mechanism, and a height scale on the height adjustment mechanism.

Although the present invention has been described in detail, it is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. A power saw comprising:
a saw assembly comprising a cutting blade for cutting along a cutting axis;
a base assembly for supporting a board to be cut by the saw assembly;
a saw mount assembly affixed to the base assembly and engaged to support the saw assembly over the base assembly to make a tilted cut while substantially maintaining the cutting blade in the cutting axis, the saw mount assembly comprising:
a track block affixed to the base assembly, said track block comprising one or more arc-shaped openings defined with reference to an apparent center point that is inline with the cutting axis; and
a saw assembly mounting block affixed to the saw assembly and engaged with the one or more arc-shaped openings in the track block to rotate about the apparent center point in relation to the track block.

2. The power saw of claim 1, where the saw assembly comprises a motor, a blade, a blade guard, and an anti-kickback device.

3. The power saw of claim 1, where the base assembly comprises a base and turntable with guide channels and a turntable lock.

4. The power saw of claim 1, where the track block comprises a laminated or single solid body in which are formed first and second arc-shaped openings that are located on concentric arcs defined with reference to the apparent center point.

5. The power saw of claim 1, where the saw assembly mounting block comprises one or more rollers which are positioned to engage with the one or more arc-shaped openings in the track block to rotate about the apparent center point in relation to the track block.

6. The power saw of claim 1, where the saw assembly mounting block comprises one or more protruding flanges which are positioned to engage with the one or more arc-shaped openings in the track block to rotate about the apparent center point in relation to the track block.

7. The power saw of claim 1, further comprising a locking device for affixing the saw assembly mounting block to the track block at a set tilt angle.

8. The power saw of claim 1, further comprising a retainer plate affixed to the saw assembly mounting block for securing the saw assembly mounting block to the track block.

9. The power saw of claim 1, further comprising:
a rail support slidingly engaged with the one or more arc-shaped openings in the track block for moving the saw assembly forward and backward in line with the cutting axis; and
a slide position lock piece assembly releasably affixed to the saw assembly mounting block and slidingly engaged with the rail support to prevent movement of the saw assembly forward and backward in line with the cutting axis.

10. A tilt cut power saw comprising:
a saw assembly attached to a base assembly with a tilting saw mount assembly for making non-vertical cuts, the tilting saw mount assembly comprising:
a fixed track block comprising one or more arc-shaped openings; and
a saw assembly mounting block that is attached to the saw assembly and that is engaged with the one or more arc-shaped openings in the fixed track block so that the saw assembly rotates about an apparent center point that is defined with reference to the one or more arc-shaped openings.

11. The tilt cut power saw of claim 10, where the tilting saw mount assembly further comprises one or more rollers assembled to rotate about an associated one or more shafts fixed to the saw assembly mounting block so that the one or more rollers engage with the one or more arc-shaped openings in the fixed track block.

12. The tilt cut power saw of claim 10, where the tilting saw mount assembly further comprises one or more flanges fixed to the saw assembly mounting block so that the one or more flanges engage with the one or more arc-shaped openings in the fixed track block.

13. The tilt cut power saw of claim 10, where the tilting saw mount assembly further comprises a retainer plate that is permanently or releasably affixed to the saw assembly mounting block for securing the fixed track block between the retainer plate and the saw assembly mounting block.

14. The tilt cut power saw of claim 10, where the tilting saw mount assembly further comprises a locking device for affixing the saw assembly mounting block to the fixed track block at a set tilt angle mechanism for making a tilt cut.

15. The tilt cut power saw of claim 10, further comprising a slide support assembly that is engaged with the one or more arc-shaped openings in the fixed track block so that the saw assembly moves along a cutting axis.

16. The tilt cut power saw of claim 15, further comprising a locking device for affixing the saw assembly to a fixed position on the slide support assembly.

17. A tilt cut power saw that can be converted into a table saw, a miter saw or a radial saw, comprising:
a base assembly with a cutting channel formed in a cutting surface for supporting a board to be cut;
a saw assembly comprising a cutting blade for cutting along a cutting axis aligned with the cutting channel; and
a saw mount assembly affixed to the base assembly and engaged to support the saw assembly over the base assembly to make a tilted cut while substantially maintaining the cutting blade in alignment with the cutting axis, the saw mount assembly comprising:
a track block affixed to the base assembly, said track block comprising one or more arc-shaped openings defined with reference to an apparent center point that is inline with the cutting axis; and
a saw assembly mounting block affixed to the saw assembly and engaged with the one or more arc-shaped openings in the track block to rotate about the apparent center point in relation to the track block.

18. The tilt cut power saw of claim 17, where the track block comprises a laminated or single solid body in which are formed first and second arc-shaped openings that are located on concentric arcs defined with reference to the apparent center point.

19. The tilt cut power saw of claim 17, where the saw assembly mounting block comprises one or more rollers which are positioned to engage with the one or more arc-shaped openings in the track block to rotate about the apparent center point in relation to the track block.

20. The tilt cut power saw of claim 17, where the saw assembly mounting block comprises one or more protruding flanges which are positioned to engage with the one or more arc-shaped openings in the track block to rotate about the apparent center point in relation to the track block.
